(19) United States
(12) Patent Application Publication
(10) Pub. No.: US 2013/0140397 A1
(43) Pub. Date: Jun. 6, 2013

(54) Woody's easy fencing system

(71) Applicant: Philip E. Woodruff, Arroyo Hondo, NM (US)

(72) Inventor: Philip E. Woodruff, Arroyo Hondo, NM (US)

(21) Appl. No.: 13/175,856

(22) Filed: Dec. 2, 2011

(51) Int. Cl. B65H 49/00; B25B 25/00

(52) U.S. Cl. 242/594; 254/199

(57) ABSTRACT

The barbwire & barb-less wire dispenser of 5 spools at one time enables a person or persons to dispense anywhere from 600 ft. to a 1/4 of a mile of 5 separate wires & the 5 wire puller allows for the tighten of 5 said wires (barbwire or barb-less wire) at one time, allowing for all 5 wires to be tighten at the same tension with just one puller instead of 5 different times with a single wire puller. The construction of the devices are of 10/20 steel and supported with same 10/20 steel allows for more wire to be strung in a single days time. With the wire spacing which is customary of current spacing of barbwire & barb-less wire Fences today. It will allow for much better an faster stringing of wire fencing. An add a more uniform eye appeal to all fencing done in the future.

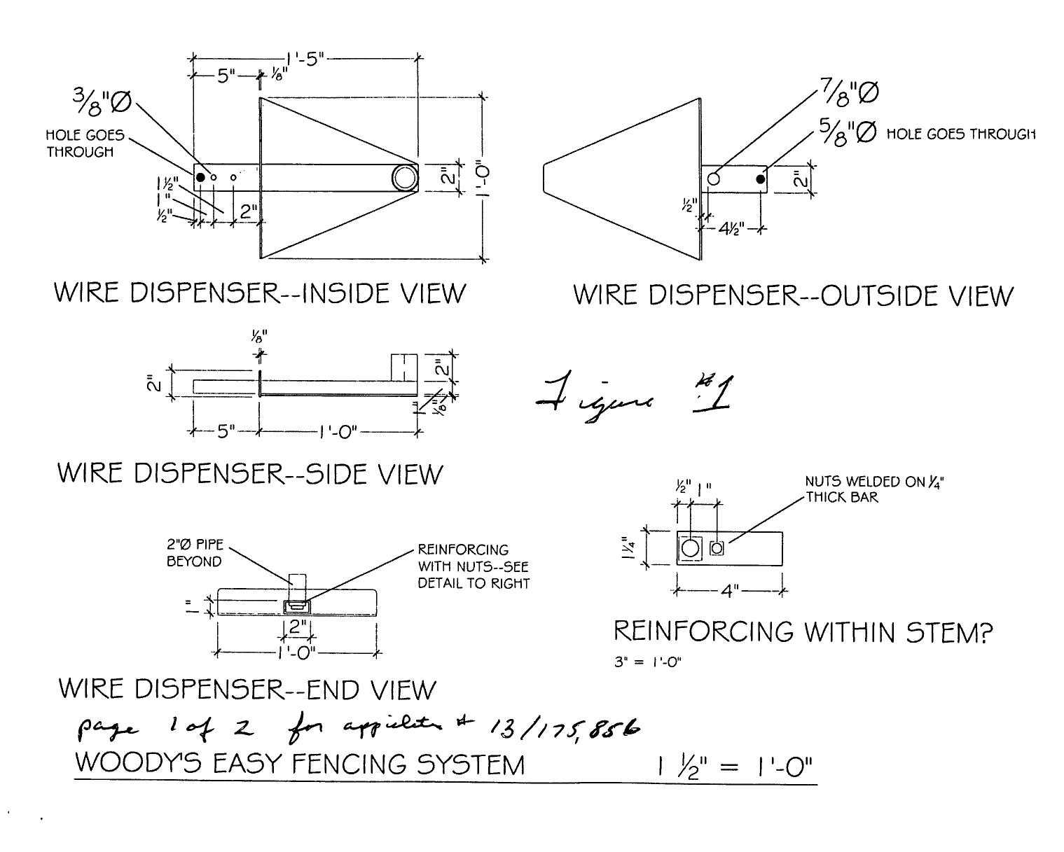

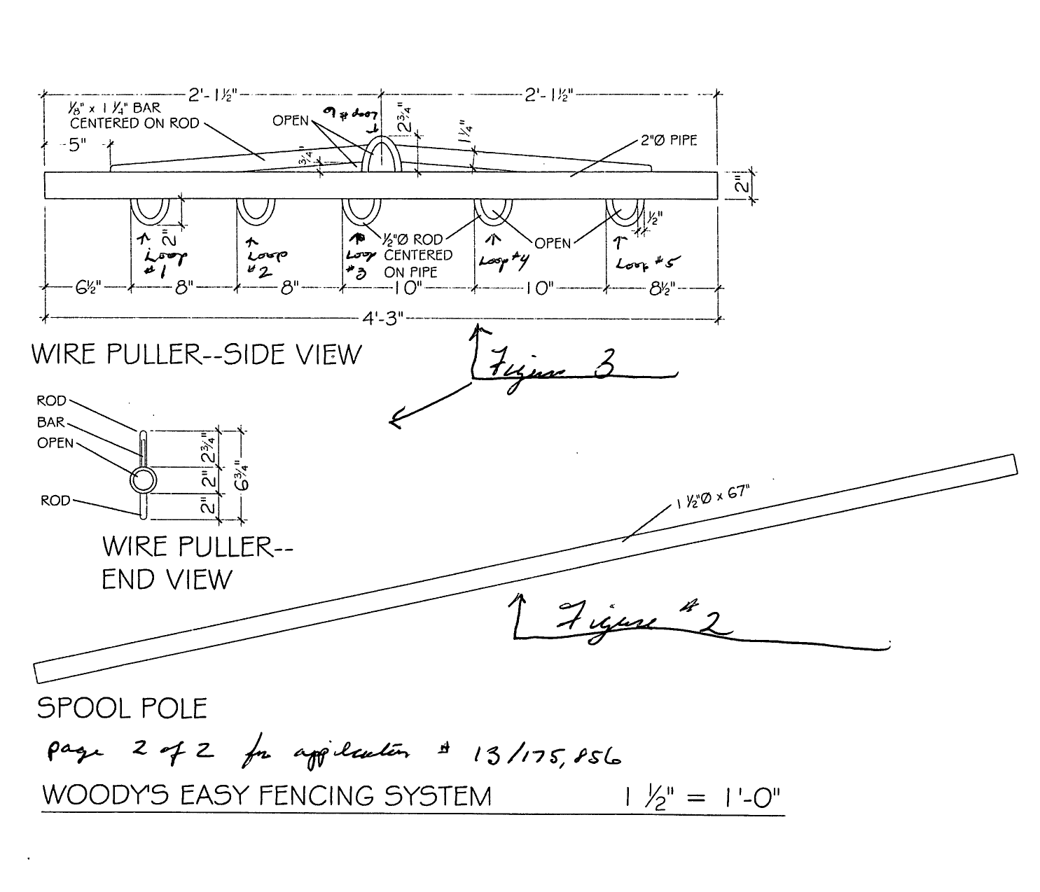

My wire dispenser is made from 10/20 solid carbon steel plating ¼ thick & 2″×1″tubular steel and a 2″×3″ steel tube all meg welded together with metal shield mc-6 wire and a wire size of 0.045 and is accompanied with a 1½ ″×67″ pipe that fits in each dispenser in order to hold 5 rolls of barbwire and or barb-less wire in a horizontal position so all 5 wires can be rolled out at the same time along the fence line to be strung. The bottom part of the dispenser has 5″ of tubular steel beyond base plate to be able to slide into the stake bed holes on the side of most pick-ups and then has a series of holes drilled in and reinforced with ¼″×1¼″ solid steel plate with nuts welded inside tube so the device can be bolted to side of truck. At the top of the dispenser where the pole fits the 2″ pipe that receives the 1½″ pipe is welded with solid metal to create a stop so if the truck stringing wire hits a pot hole or rough roads the pole and 5 rolls of wire will remain on the dispenser

My wire puller is made of 10/20 steel tubular pipe ⅛″×2″ by 51″ long, an has 6 loops attached 5 of them on one side and one on the back side. The loops are made of 10/20 solid tubular ½″ steel welded to pole as follows, the bottom loop #1 is 6½″ from bottom of pole, #2 loop is welded 8″ above #1 and #3 is welded 8″ from #2 and #4 is welded 10″ from #3, and #5 is welded 10″ from #4 all meg welded with metal shield mc-6 and has a wire thickness of 0.045. The pulling side of pole has one loop welded 25½″ to center with ¼″×19″ steel strap welded to each side of loop for added pulling strength again welded with metal shield mc-6 wire size of 0.045.

The wire dispenser (The tree looking part of device) is designed to fit in the stake bed holes on the sides of pick-up trucks. One on one side and one on the other and then after loading the center pole with 5 rolls of barbwire you then put pole into dispenser an then bolt it into place using provide dealership holes already in bed of truck. The holes on my device have been matched to the dealership holes on the following makes of truck Chevy, Dodge, Ford, and Gmc. The bottom hole on my device has been designed for flatbed trucks, and the provided push pin will hold device in place. The device has been built to give 1′ clearance above side of truck. After dispenser is loaded with wire then you roll out bout 10′ of lead wire attach it to puller, before you go any further you now tie each roll of barbwire individually together so that all wire is evenly laid out. Now get your puller and walk it over to starting point of the fence you then stand pole up to corner post making sure that the top wire is #5, which is the one that comes off truck on the driver side. Now staple or tie wire to beginning point and untie puller, now drive along fence your desired distance of fence you want to put up or the amount of a roll which is 1252 ft. Now reconnect the puller to the wire making sure that when connected the #5 wire will attach to pole towards driver side of truck. Now attach com-a-long or wench an start taking up the slack in wire an as you do you will see that the wire will stand up to the fence perfectly spaced and ready to be tied to the T-poles. The spacing of the wires should be as follows, from top to bottom #5 wire 10″ from #4 wire, and #4 wire 10″ from #3 wire, and #3 wire 8″ from #2 wire and finally #2 wire 8″ from #1 wire.

1. Now you have a 5 wire fence up at a quarter mile at a time. My puller has been designed, and has the strength to pull the memory out of the wire so in case of wire breakage the wire will fall to ground and not recoil at the workers. That is how my invention works, when ready for market I plan on putting dvds showing and explaining how device works. With this device a mile of fence is possible in a day instead of a week. It will also help all fences of the barbwire nature to be seen as uniformed along all highways, ranches etc. This is my invention the only 5 wire dispenser of barbwire and the only 5 wire puller of said wire. This is my claim, as far as I know there is nothing out there that compares to this time sing device in both labor and time it takes to install. If you can help me get this expedited I would be grateful, cause with all the fires that New Mexico, Texas and Arizona had and all the fences that were lost I Believe with this device everybody can get back on track of saving there ranches, and keeping there animals safe.
